(19) United States
(12) Patent Application Publication
(10) Pub. No.: US 2016/0019615 A1
(43) Pub. Date: Jan. 21, 2016

(54) Mapping and Procurement System

(71) Applicant: 1-800 Radiator & A/C, Benicia, CA (US)

(72) Inventors: Julian Hart, Las Vegas, NV (US); Kenneth Keala, Benicia, CA (US)

(21) Appl. No.: 14/333,274

(22) Filed: Jul. 16, 2014

(51) Int. Cl. G06Q 30/06

(52) U.S. Cl. CPC G06Q 30/0611

(57) ABSTRACT

Methods and systems are described for generating a list of aftermarket parts that match a fit with a Vehicle Identification Number as well as a description of the part to be replaced. The methods interface with existing quoting platforms. According to one embodiment, the method and system describes receiving a Request For a Quote, querying a database for matching parts, returning the list, receiving a part selection, querying a database for shipping information, ordering the part, and returning an order confirmation.

### FIELD OF THE INVENTION

Embodiments of the present invention relate generally to sale of aftermarket auto parts. More particularly, embodiments of the invention relate to a computer system for finding and ordering a properly fitting aftermarket part for an identified vehicle.

### BACKGROUND

Linking a vehicle with its correct aftermarket parts is often a frustrating task. The language and data used to describe vehicle attributes may not match that used to describe part attributes. As a result, distributors and service providers often resort to buying multiple parts, trying them on the vehicle, and then returning those that don't fit. This inefficient and slow process can lead to increased costs in the supply chain and the repair workflow.

Systems exist for estimating the cost of repairs and for automatic quoting. Automatic quoting systems generally operate by receiving an estimate from a system that a repair or appraisal technician interacts with, generating and passing a request for a quote (RFQ) to suppliers, receiving quotes and presenting them to the repair or appraisal facility, receiving the repair or appraisal facility's input regarding the quotes, generating and sending a purchase order, and storing the purchase in an audit log.

While these systems provide a method to generate a request for a quote (RFQ), they are typically not automated during the step of obtaining quotes from suppliers. Similarly, these systems are typically not automated during the step of sending a purchase order and obtaining an invoice.

### BRIEF DESCRIPTION OF THE DRAWINGS

Embodiments of the invention are illustrated by way of example and not by way of limitation in the figures of the accompanying drawings in which like references indicate similar elements. It should be noted that different references to “an” or “one” embodiment in this disclosure are not necessarily to the same embodiment, and such references mean at least one.

FIG. 1 is a diagram of one embodiment of the part mapping and procurement system showing how it interacts with existing estimate and quote systems.

FIG. 2 is a diagram of one embodiment of the part mapping system.

FIG. 3a is a diagram of one embodiment of the part mapping and procurement system, in which the part mapping system and part procurement system are software modules executed by the processor of the part mapping and procurement system.

FIG. 3b is a diagram of one embodiment of the part mapping and procurement system, in which the part mapping system and part procurement system are separate hardware system that interface with the part mapping and procurement system.

FIG. 4 a flow diagram of one embodiment of the part mapping and selection method employed by the part mapping and procurement system.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

Various modifications and changes can be made to the embodiments without departing from the broader spirit and scope of the invention as set forth in the appended claims. The specification and drawings are, accordingly, to be regarded in an illustrative rather than a restrictive sense.

The embodiments can be implemented in numerous ways, including as a process, an apparatus, a system, a composition of matter, a computer readable medium such as a computer readable storage medium or a computer network wherein program instructions are sent over optical or communication links. A component such as a processor or a memory described as being configured to perform a task includes both a general component that is temporarily configured to perform the task at a given time or a specific component that is manufactured to perform the task. In general, the order of the steps of disclosed processes can be altered within the scope of the invention.

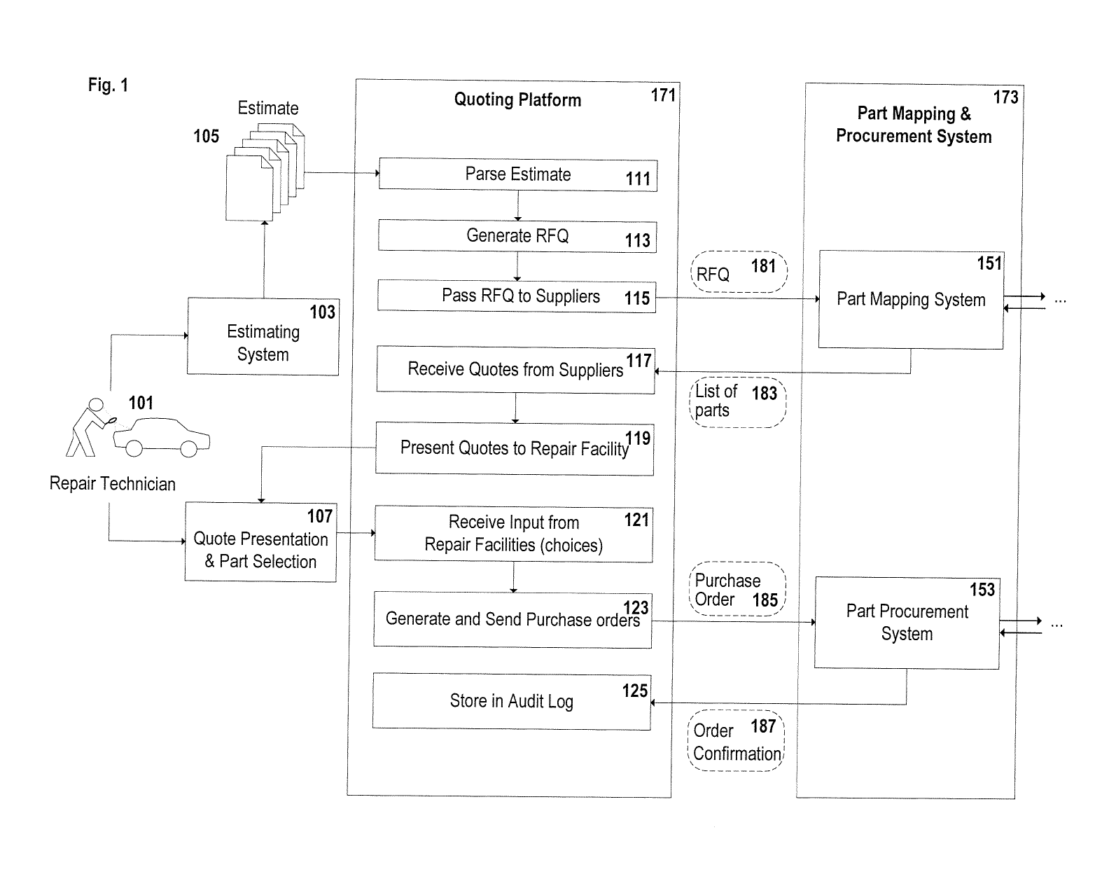

FIG. 1 is a diagram of one embodiment of the part mapping and procurement system 173 showing how it interacts with an existing estimate and quote system 171. The estimate and quote system 171 illustrated in FIG. 1 is intended to be exemplary rather than limiting.

Generally, the process of repairing a car begins with a repair technician 101 diagnosing an issue with a car. In many situations, this requires replacement of a car part, and in many cases the part sourced may not be an OEM part from the vehicle manufacturer's authorized distributors. Examples of these non-OEM parts include aftermarket, reconditioned, remanufactured, and discount-OEM (surplus OEM or blemished) parts. In some embodiments, the repair technician 101 may instead be an appraisal technician. The term “repair technician” and “repair facility” should be interpreted to also include appraisal technicians and appraisal facilities, respectively. In some embodiments, the repair technician 101 describes the issue with the car into an estimating system 103, which formats an estimate 105 that is sent to a quoting platform 171, inside which the estimate is parsed (block 111). In one embodiment, the quoting platform 171 can be, for example, PartsNetwork by APU Solutions, Overland Park, Kans. The quoting platform 171 can alternately be any other system having functionalities capable of processing estimates received from the estimating system 103 (block 111), generating an RFQ 181 (block 113), passing an RFQ to suppliers (block 115), receiving quotes from suppliers (block 117) and presenting them to a repair facility (block 119) in order to receive a selection (block 121) generating and sending a purchase order (block 123), and storing an order confirmation in an audit log (block 125), or any system similar to those described in block 171 of FIG. 1.

In some embodiments, the estimate 105 that is sent from the estimating system 103 to the quoting platform 171 includes a Vehicle Identification Number (VIN). In other embodiments, the estimate 105 describes a vehicle in terms of make, model, and model year. In some embodiments, the estimate 105 also includes a preliminary description of a part to be replaced in the vehicle identified by the VIN. In some embodiments, the estimate 105 also includes a part number of a part to be replaced in the vehicle identified by the VIN. In some, the estimate 105 can include a preliminary description of a repair or set of repairs to be made to the vehicle identified by the VIN.

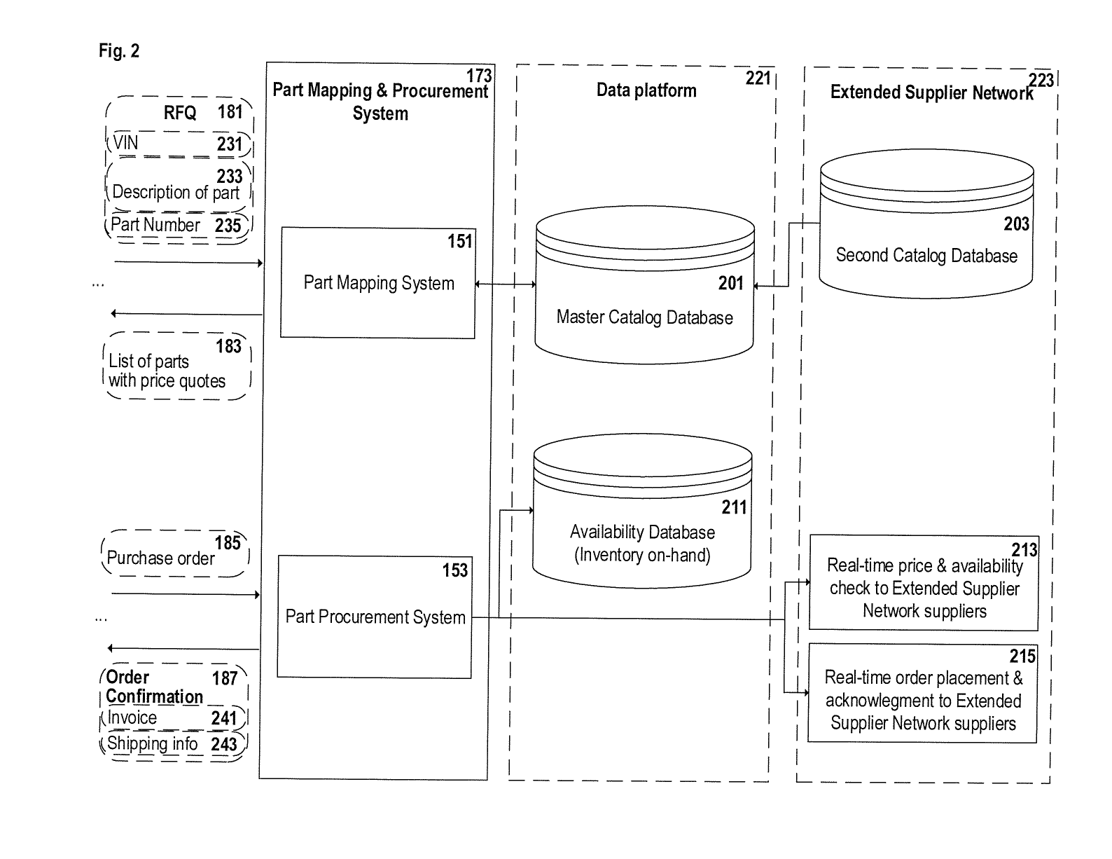

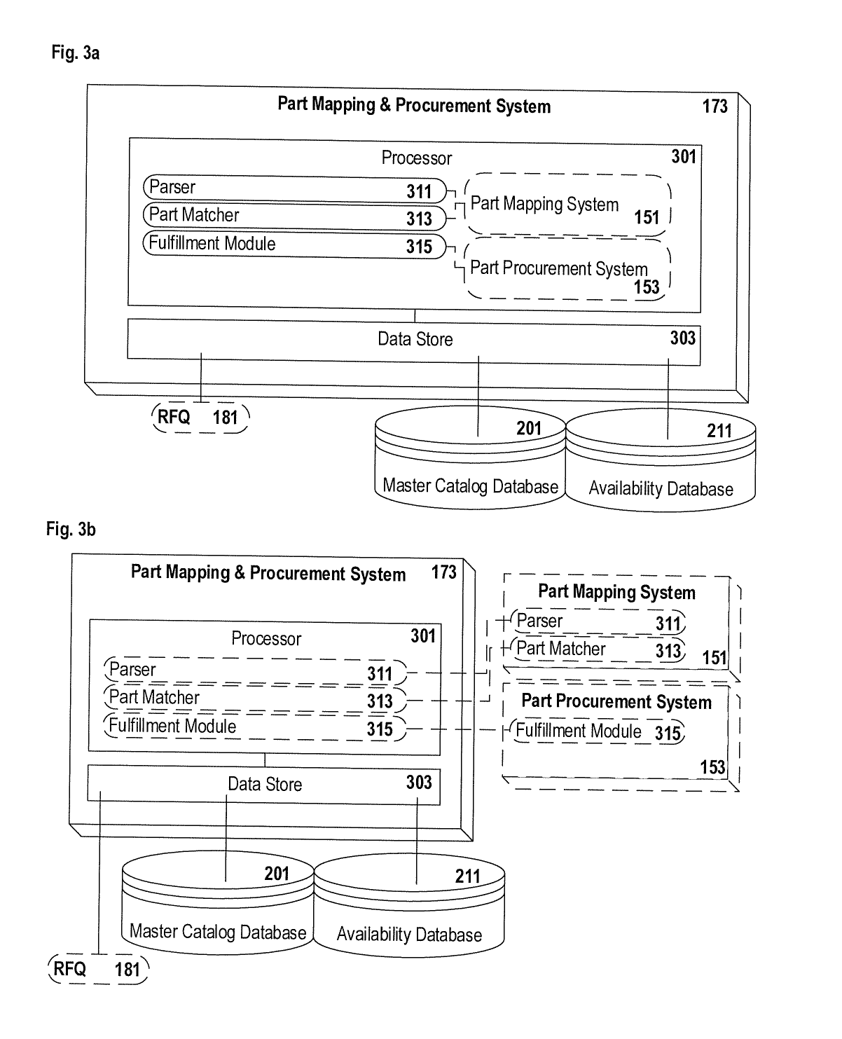

Once the estimate 105 from the estimating system 103 has been received by the quoting platform 171, the estimate 105 is parsed (block 111). The quoting platform 171 uses the parsed estimate to generate a Request For a Quote (RFQ) 181 (block 113). In some embodiments, the Request For a Quote 181 contains at least a Vehicle Identification Number (VIN) 231, a description of the part that needs to be replaced 233, and a part number of the part that needs to be replaced 235. Such an embodiment of the RFQ 181 is shown in more detail in FIG. 2. The RFQ 181 is then sent by the quoting platform 171 to be used as the input for the part mapping and procurement system 173 (block 115). In some embodiments, the RFQ 181 is more specifically used as the input for the part mapping system 151. More details regarding the interplay between the part mapping and procurement system 173 and the part mapping system 151 are illustrated in FIG. 3a and FIG. 3b and are described in the descriptions of those figures.

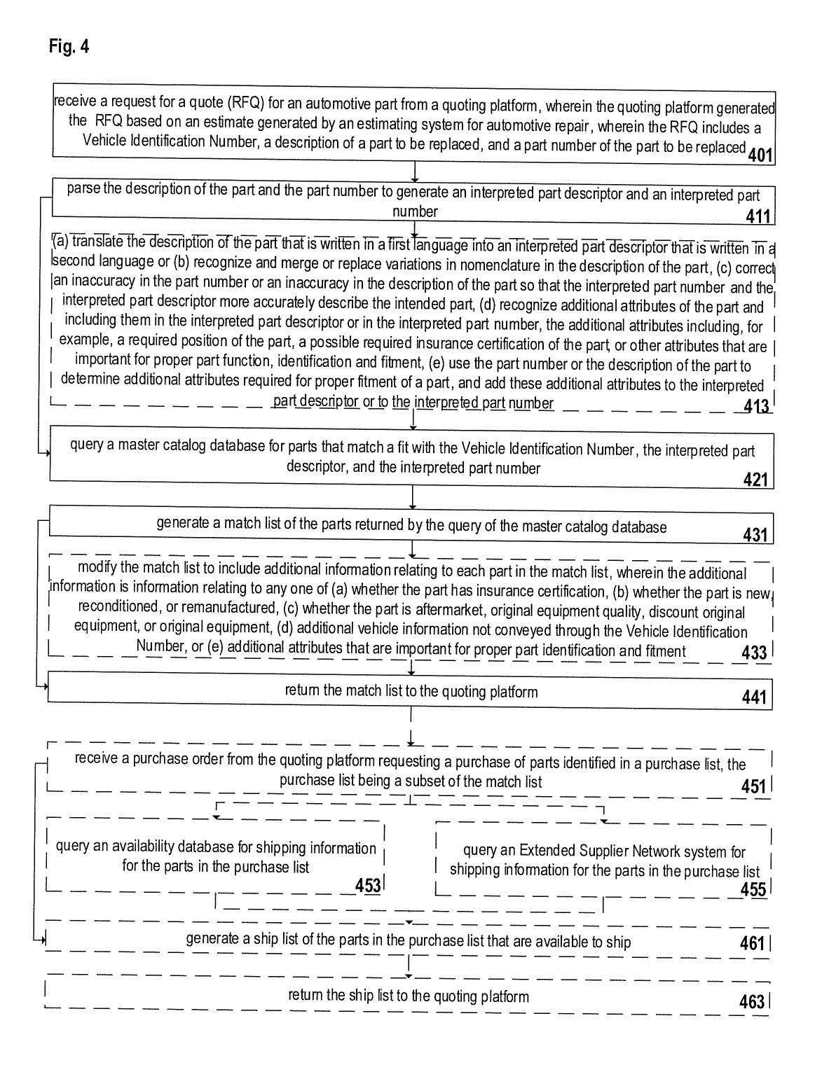

After the part mapping system 151 receives a RFQ 181 as an input, it then outputs a list of parts 183 that would fit the vehicle described by the VIN number 231, the description of the part 233, and the part number 235. Some embodiments of the method used by the part mapping system 151 to generate this list of parts 183 are illustrated in FIG. 2 and FIG. 4.

In some embodiments, the list of parts 183 identifies parts from various vendors. In other embodiments, the list of parts 183 only identifies parts that are made by a single vendor. In some embodiments, the list of parts 183 may identify parts made by the OEM, while in others, the list of parts only identifies parts from third party aftermarket part manufacturers. In some embodiments, the list of parts 183 includes a price for each part identified in the list. The part mapping and selection module 151 outputs this list of parts 183 to the quoting platform 171, which receives it (block 117).

Once the quoting platform 171 receives the list of parts and their price quotes 183 (block 117), it presents the quotes to the repair facility (block 119), typically as a list of choices. The repair technician 101, the client, or some other appropriate person then generally selects a part from the list (block 107) and the quoting platform 171 receives this choice (block 121). Afterwards, the quoting platform 171 generates a purchase order 185 based on the choice made by the repair facility (block 123). Once generated, the purchase order is sent to the part mapping and procurement system 173, and, more specifically, the part procurement system 153. More details regarding the interplay between the part mapping and procurement system 173 and the part procurement system 153 are illustrated in FIG. 3a and FIG. 3b and are described in the descriptions of those figures.

The part procurement system 153, part of the part mapping and procurement system 173, then accepts the purchase order 185 that was generated in block 123 as an input. In some embodiments, the part procurement system 153 then returns an order confirmation 187 back to the quoting platform 171. In some embodiments, as detailed in FIG. 2, the order confirmation 187 includes an invoice 241 detailing the amounts paid or payable. In some embodiments, the order confirmation 187 also includes shipping information 243, which can detail ship dates, estimated arrival dates, and shipping costs paid or payable. The quoting platform 171 typically receives the order confirmation 187 and stores it in an audit log (block 125).

The embodiments of the quoting platform 171 depicted in FIG. 1 are to be regarded in an illustrative rather than a restrictive sense. The graphical representations in each of the figures are exemplary and not intended as a requirement for every embodiment of a quoting platform 171, and are further not intended to limit the scope of the inputs and outputs received and generated by the part mapping and procurement system 173. Various modifications and changes can be made to the embodiments without departing from the broader spirit and scope of the invention as set forth in the appended claims.

FIG. 2 is a diagram of one embodiment of the part mapping and procurement system 173.

The part mapping and procurement system 173 can be divided into the part mapping system 151 and the part procurement system 153. In some embodiments, the part mapping system 151 and the part procurement system 153 are physically separate hardware systems, such as separate computers. In other embodiments, the part mapping and procurement system 173 is a single computer or other hardware device, and the part mapping system 151 and the part procurement system 153 are simply software or hardware components of the larger part mapping and procurement system 173. These embodiments of the part mapping and procurement system 173 are described in further detail in FIG. 3a and FIG. 3b.

In some embodiments, the part mapping and procurement system 173 is connected to a data platform 221. The data platform 221 includes a master catalog database 201 and an availability database 211. In some embodiments, the master catalog database 201 and availability database 211 are not actually separate databases, but the data from each database is simply a subset of the data within a single “combined” database (not pictured). Any further mentions of the master catalog database 201 and the availability database 211 in the current specification may also be read to refer to a single “combined” database in place of these two. In one embodiment, these databases may use the Auto Care Association (ACA, formerly the Automotive Aftermarket Industry Association (AAIA)) Catalog Enhanced Standard (ACES). These databases may also use the ACA Product Information Enhanced Standard (PIES), as well as other, non-standard data structures. In another embodiment, these databases may use another suitable catalog database format. The databases 201, 211 can be data sets managed by any type or implementation of a database managements system, including relational or objected oriented database systems. In some embodiments, the each of the databases 201 and 211 can alternately be another data structure, such as a table, a list, a matrix, an array, an arraylist, a tree, a hash, a flat file, an image, a queue, a heap, a memory, a stack, a set of registers, or any data structure that can hold data about one or more entities.

In some embodiments, individual suppliers from an extended supplier network 223 have their own internal catalog databases. Such a catalog database is illustrated in FIG. 2 as the second catalog database 203. In some embodiments, a supplier who owns such a second catalog database 203 can request that the second catalog database 203 be added to the master catalog database 201. In other embodiments, a second catalog database 203 may be publicized by the supplier, i.e., the second catalog database 203 can be made searchable and/or accessible to the data platform 221. In some embodiments, the second catalog database 203 can be made searchable and/or accessible directly to the part mapping and procurement system 173. In other embodiments, the supplier can receive a request for access to the second catalog database 203. Regardless of the method of granting access to the second catalog database 203, the data within the second catalog database 203 can be appended to or otherwise added to the master catalog database 201 according to some embodiments. Once added, the master catalog database 201 is capable to returning any result that the second catalog database 203 was previously capable of returning, with the addition of any other results that the master catalog database 201 was capable of returning prior to the addition.

The master catalog database 201 includes data about various aftermarket, reconditioned, remanufactured, and discount-OEM vehicle parts that can be used by the part mapping system 151 to produce a list of parts with price quotes 183. In some embodiments, the master catalog database 201 also includes additional information. For example, the master catalog database 201 may include information for each identified part relating to any one of (a) whether the part has insurance certification, (b) whether the part is new, reconditioned, or remanufactured, (c) whether the part is aftermarket, original equipment quality, or original equipment, (d) additional vehicle information not conveyed through the Vehicle Identification Number, or (e) additional attributes that are important for proper part identification and fitment. This is explained in more detail with regard to block 433 of FIG. 4.

The availability database 211 includes data about various aftermarket, reconditioned, remanufactured, or discount-OEM vehicle parts that can be used by the part procurement system 153 to generate an order confirmation 187 that, in some embodiments, also contains an invoice 241 denoting payments paid or payable, and shipping information 243 that can detail any one of ship dates, estimated arrival dates, and shipping costs paid or payable. In some embodiments, the availability database 211 includes data about an inventory of parts available on-hand at a particular physical location or network of locations. In some embodiments, the availability database 211 includes data about an inventory of parts available on-hand from a particular vendor, retailer, manufacturer, or distributor. In yet other embodiments, the availability database 211 includes data about a wide range of parts available from different locations, different networks of locations, different vendors, different retailers, different manufacturers, different distributors, and so forth.

In some embodiments, the availability database 211 can contain price data, shipping data, or ordering capabilities for certain parts, part storage locations, vendors of parts, retailers of parts, manufacturers of parts, or distributors of parts. In this sense, the phrase “availability database” is used in an exemplary sense, rather than a restrictive sense; the database 211 need not be restricted to availability data alone, but can in some embodiments include a variety of types of data.

In some embodiments, the part procurement system 153 can be tasked with ordering a part in which such data or ordering capabilities are missing. In such a situation, the part procurement system 153 may skip the availability database 211 and directly contact the extended supplier network 223. For example, the part procurement system 153 can perform a real-time availability and price check to extended supplier network suppliers (block 213), or the part procurement system 153 can perform a real-time order placement and acknowledgment to extended supplier network suppliers (block 215). In some embodiments, the tasks described in block 213 and block 215 are performed automatically by the part procurement system 153 through a network connection that connects the part procurement system 153 to computer systems in the extended supplier network 223.

In some embodiments, the availability database 211 also includes additional information relating to one or more parts. For example, the availability database 211 may include information for each part relating to any one of (a) whether the part has insurance certification, (b) whether the part is new, reconditioned, or remanufactured, (c) whether the part is aftermarket, original equipment quality, discount original equipment, or original equipment, (d) additional vehicle information not conveyed through the Vehicle Identification Number, and (e) additional attributes that are important for proper part identification and fitment. This is explained in more detail with regard to block 433 of FIG. 4.

The term “database” as used to refer to databases 201, 211, and 203 may refer to any data structure that may be used to store data. In addition to a relational or object oriented database, databases 201, 211, and 203 can alternately be a table, a list, a matrix, an array, an arraylist, a tree, a hash, a flat file, an image, a queue, a heap, a memory, a stack, a set of registers, or any data structure that can hold data about one or more entities.

FIG. 3a and FIG. 3b are diagrams of two embodiments of the part mapping and procurement system 173. The part mapping and procurement system 173 can include the part mapping system 151 and the part procurement system 153. In some embodiments, the part mapping system 151 and the part procurement system 153 are physically separate hardware systems, such as separate computers. This is illustrated in FIG. 3b. In other embodiments, the part mapping and procurement system 173 is a single computer or other hardware device, and the part mapping system 151 and the part procurement system 153 are simply software or hardware components of the larger part mapping and procurement system 173. This is illustrated in FIG. 3a. The illustrated embodiments are intended to be exemplary rather than restrictive; for instance, the part mapping system 151 could be executed by separate hardware from the part mapping and procurement system 173 while the part procurement system was not, or vice versa.

FIG. 3a is a diagram of one embodiment of the part mapping and procurement system 173, in which the part mapping system 151 and part procurement system 153 are software modules executed by the processor 301 of the part mapping and procurement system 173. In some embodiments, the part mapping system 151 and part procurement system 153 are hardware modules within the part mapping and procurement system 173 with access to the processor 301. In some embodiments, the part mapping system 151 and part procurement system 153 are not distinct modules from or sub-components of the part mapping and procurement system 173, and all processes described herein as executed by the part mapping system 151 and part procurement system 153 are instead performed directly by the part mapping and procurement system 173.

The part mapping and procurement system 173 as depicted in FIG. 3a may be any kind of device, such as a server, a personal computer (e.g., desktops, laptops, and tablets), a virtual machine, a “thin” client, a personal digital assistant (PDA), a Web appliance, a file server, a gaming device, a network device, a media player, a mobile phone (e.g., Smartphone), or any other machine with similar capabilities. The part mapping and procurement system 173 includes a processor 301 and a data store 303. In some embodiments, additional elements may be included, such as a network adapter, an input device, a display, a printer or other output device, or any one of a number of other elements that are typically found within or coupled to a computer system (additional elements not shown).

The processor 301 of the part mapping and procurement system 173 can be a microprocessor, an ASIC, a state machine, or other processor, and can be any of a number of computer processors. Such processors include, or may be in communication with, media, for example computer-readable media, which stores instructions that, when executed by the processor, cause the processor to perform the steps described herein. In other embodiments, the part mapping and procurement system 173 can be distributed over any number of processors or computing systems, or can be implemented in a multi-tenant and/or virtualized environment such as a cloud computing system.

According to some embodiments, the processor 301 can execute a parser 311, part matcher 313, and a fulfillment module 315. The tasks performed by these modules are discussed in more detail in reference to FIG. 4. According to some embodiments, the processor 301 also executes at least one of the part mapping system 151 and the part procurement system 153. Further, in the embodiment depicted in FIG. 3a, the part mapping system 151 is operable to interact with the parser 311 and the part matcher 313, while the part procurement system 153 is operable to interact with the fulfillment module 315. These interactions are discussed in more detail in reference to FIG. 4.

The data store 303 of the part mapping and procurement system 173 can include hard disk drive storage, optical drive storage, tape drive storage, random access memory (RAM), read-only memory (ROM), programmable read-only memory (PROM), Redundant Arrays of Independent Disks (RAID), flash memory, magneto-optical memory, holographic memory, memristor-based memory, bubble memory, magnetic drum, memory stick, polyester film tape, smartdisk, thin film memory, zip drive, or similar storage or memory hardware.

According to some embodiments, the part mapping and procurement system 173 can receive a RFQ 181. Typically, the part mapping and procurement system 173 would store a RFQ 181 in its data store 303, at least temporarily. In some embodiments, the part mapping and procurement system 173 is also connected the master catalog database 201 and the availability database 211. In some embodiments, the master catalog database 201 or the availability database 211, or both, are stored within the data store 303 of the part mapping and procurement system 173, either partially (such as in random access memory) or in their entirety. In some embodiments, these are connected using a network connection, such as a local area network (LAN), a wireless local area network (WLAN), a standard Ethernet internet connection, or some other suitable specialized connection. In such embodiments, parts of master catalog database 201 or availability database 211 may be stored within the data store 303 temporarily. In other embodiments, the entirety of the master catalog database 201 or availability database 211, or both, may be stored within the data store 303 at all times.

If the databases 201 and 211 are not stored within the data store 303 at all times but are instead connected to the part mapping and procurement system 173 through a network, then these databases may be stored in the data store of another hardware system. For instance, the databases 201 and 211 may be stored in a structured query language (SQL) server, a web front-end server, a central administration server, an index server, a database server, an application server, a gateway server, a broker server, an active directory server, a terminal server, a virtualization services server, a virtualized server, a file server, a print server, an email server, a security server, a connection server, a search server, a license server, any other machine with similar functionality.

As mentioned previously, the term “database” is intended to be illustrative rather than restrictive, and may refer to any data structure that may be used to store data. In addition to a relational or object oriented database, databases 201, 211, and 203 can alternately be a table, a list, a matrix, an array, an arraylist, a tree, a hash, a flat file, an image, a queue, a heap, a memory, a stack, a set of registers, or any data structure that can hold data about one or more entities.

FIG. 3b is a diagram of one embodiment of the part mapping and procurement system, in which the part mapping system and part procurement system are separate hardware systems that interface with the part mapping and procurement system. In some embodiments, as pictured, the part mapping system 151 and the part procurement system 153 are both connected to the part mapping and procurement system 173 via a network technology, such as a local area network (LAN), a wireless local area network (WLAN), a standard Ethernet internet connection, or some other suitable specialized connection. In other embodiments, the part mapping system 151 and the part procurement system 153 are instead connected to each other via such a network connection, and one or both are also connected to the part mapping and procurement system 173. In an alternate embodiment, the part mapping system 151 and the part procurement system 153 are connected to each other, and the part mapping and procurement system 173 is merely an umbrella term used to refer to these two connected systems 151 and 153, rather than being a physical system.

As with the part mapping and procurement system 173, the part mapping system 151 and part procurement system 153 as depicted in FIG. 3b may each be any kind of device, such as a server, a personal computer (e.g., desktops, laptops, and tablets), a virtual machine, a “thin” client, a personal digital assistant (PDA), a Web appliance, a file server, a gaming device, a network device, a media player, a mobile phone (e.g., Smartphone), or any other machine with similar capabilities. These systems can each include a processor and a data store. In some embodiments, additional elements may be included, such as a network adapter, an input device, a display, a printer or other output device, or any one of a number of other elements that are typically found within or coupled to a computer system.

As above, the processor 301, along with the processor within the part mapping system 151 (not pictured) and the processor within the part procurement system 153 (not pictured), can be a microprocessor, an ASIC, a state machine, or other processor, and can be any of a number of computer processors. Such processors include, or may be in communication with, media, for example computer-readable media, which stores instructions that, when executed by the processor, cause the processor to perform the steps described herein. In other embodiments, the part mapping system 151 and part procurement system 153 can each be distributed over any number of processors or computing systems, or can be implemented in a multi-tenant and/or virtualized environment such as a cloud computing system.

Also as above, the data store 303, along with the data store of the part mapping system 151 (not pictured) and the data store of the part procurement system 153 (not pictured), can include hard disk drive storage, optical drive storage, tape drive storage, random access memory (RAM), read-only memory (ROM), programmable read-only memory (PROM), Redundant Arrays of Independent Disks (RAID), flash memory, magneto-optical memory, holographic memory, memristor-based memory, bubble memory, magnetic drum, memory stick, polyester film tape, smartdisk, thin film memory, zip drive, or similar storage or memory hardware.

In some embodiments, the part mapping and procurement system 173 is not a separate system, but instead, the parser 311 and part matcher 313 are executed by the processor (not shown) of the part mapping system 151, while the fulfillment module 315 is executed by the processor (not shown) of the part procurement system 153. In other embodiments, the part mapping system 151 and part procurement system 153 assist the processor 301 in executing the parser 311, part matcher 313, and fulfillment module 315. In still other embodiments, the parser 311, part matcher 313, and fulfillment module 315 is executed by the processor 301 despite the part mapping system 151 and part procurement system 153 being physically separate from the part mapping and procurement system 173. The processes executed by these modules are explained further in reference to FIG. 4.

The embodiments of the Part Mapping and Procurement System 173 depicted in FIG. 3a and FIG. 3b and otherwise described herein are to be regarded in an illustrative rather than a restrictive sense. The graphical representations in each of the figures are exemplary and not intended as a requirement for every embodiment of the Part Mapping and Procurement System 173. Various modifications and changes can be made to the embodiments without departing from the broader spirit and scope of the invention as set forth in the appended claims.

FIG. 4 a flow diagram of one embodiment of the part mapping and selection method employed by the part mapping and procurement system 173. In some embodiments, the processes described in each block of the flow diagram are all performed by a single hardware machine, such as the centralized part mapping and procurement system 173 as depicted in FIG. 3a. In other embodiments, the processes described in each block of the flow diagram may be performed by different hardware machines or distributed in a virtualized and/or multi-tenant system, such as the interconnected part mapping and procurement system 173, part mapping system 151, and part procurement system 153 depicted in FIG. 3b, a data center, cloud computing system or similar implementation.

During the method, the part mapping and procurement system 173 receives a request for a quote (RFQ) 181 from a quoting platform 171 (block 401). The quoting platform 171 generated the RFQ 181 based on an estimate 105. The RFQ 181 includes a Vehicle Identification Number (VIN) 231, a description of a part 233 to be replaced, and a part number 235 of the part to be replaced. In some embodiments, the RFQ 181 also contains additional information that identifies that part as, for example, an Original Equipment part, an aftermarket part from another manufacturer, insurance-approved certified part, or some other type of part. These part numbers supplied in the RFQ may or may not accurately identify the proper part for the vehicle to be repaired, and may need to be corrected during an interpretation or parsing process in order to accurately identify the proper part. In some embodiments, this interpretation or parsing process is performed by the parser 311. In some embodiments, this interpretation or parsing process is performed by the part mapping system 151.

Once the part mapping and procurement system 173 receives the request for a quote (RFQ) 181 including the description of the part 233 and part number 235, it parses the description of the part into an interpreted part descriptor (not pictured in FIG. 2) and it parses the part number of the part into an interpreted part number (not pictured in FIG. 2) (block 411). In some embodiments, one of the description of the part 233 or the part number may be missing. In some embodiments, the parsing process includes translating the description of the part 233 that is written in a first language into an interpreted part descriptor that is written in a second language (block 413a). In some embodiments, the parsing process includes recognizing variations in nomenclature that refer to similar parts within the description of the part 233 and adjusting these (i.e., merging or replacing these variations in nomenclature) within the interpreted part descriptor (block 413b). In some embodiments, the parsing process includes correcting an inaccuracy in the part number (e.g., extra digits, missing digits, wrong size/version/shape/year/model/fitment of a part, wrong part, etc.) or an inaccuracy in the description of the part (e.g., misspelling, wrong size/version/shape/year/model/fitment of a part, wrong part, etc.) so that the interpreted part number and the interpreted part descriptor more accurately describe the intended part (block 413c). In some embodiments, the parsing process includes recognizing additional attributes of the part and including them in the interpreted part descriptor or in the interpreted part number, the additional attributes including, for example, a required position of the part, a possible required insurance certification of the part, or other attributes that are important for proper part function, identification and fitment (block 413d). In some embodiments, the parsing process includes using the part number or the description of the part 233 to determine additional attributes required for proper fitment of a part, and adding these additional attributes to the interpreted part descriptor or to the interpreted part number (block 413e). In some embodiments, the parsing process is performed by the parser 311. In some embodiments, the parsing process is performed by the part mapping system 151.

The method also includes the part mapping and procurement system 173 querying the master catalog database 201 for parts that match a fit with the Vehicle Identification Number (VIN) 231 and the interpreted part descriptor (block 421). In embodiments in which the master catalog database 201 is connected to the part mapping and procurement system 173 via a network, the query described in block 421 can be a Structured Query Language (SQL) query, a Sparql Protocol and RDF Query Language (SPARQL) query, an RDF query, a Datalog query, a Lightweight Directory Access Protocol (LDAP) query, an XQuery query, an OPath query, a MultiDimensional eXpressions (MDX) query, an Object Query Language (OQL) query, a QUEL query, an Object Constraint Language (OCL) query, a Language Integrated Query (LINQ) query, or another appropriate type of query. The query can be sent using Hypertext Transfer Protocol (HTTP), Hypertext Transfer Protocol Secure (HTTPS), File Transfer Protocol (FTP), Transport Layer Security (TLS), Secure Sockets Layer (SSL), User Datagram Protocol (UDP), Simple Mail Transfer Protocol (SMTP), Wireless Application Protocol (WAP), Bluetooth, or similar communications or security protocols. In embodiments in which the master catalog database 201 is stored in data store 303, the query described in block 421 can simply be a database lookup, or a similar or analogous function if the master catalog database 201 is a different data structure. In some embodiments, the query described in block 421 is performed by the part matcher 313. In some embodiments, the query described in block 421 is performed by the part mapping system 151.

The method also includes the part mapping and procurement system 173 generating a match list of the parts that match a fit with the Vehicle Identification Number (VIN) 231 and the interpreted part descriptor (block 431). In some embodiments, this generation is a receipt of the list from the master catalog database 201 in response to the query of block 421. In some embodiments, the part mapping and procurement system 173 receives the results of the query from the master catalog database 201 in real-time or in a piecemeal fashion, and as such must gather the results together in the match list. In some embodiments, the match list is generated by the part matcher 313. In some embodiments, the match list is generated by the part mapping system 151.

The term “list” is intended to be exemplary rather than restrictive. The match list can alternately be a data structure such as a database, a table, a matrix, an array, an arraylist, a tree, a hash, a flat file, an image, a queue, a heap, a memory, a stack, a set of registers, or any data structure that can hold data about one or more entities.

In some embodiments, the part mapping and procurement system 173 can also modify the match list to include additional information relating to each part in the match list, wherein the additional information is information relating to any one of (a) whether the part has insurance certification, (b) whether the part is new, reconditioned, or remanufactured, (c) whether the part is aftermarket, original equipment quality, discount original equipment, or original equipment, (d) additional vehicle information not conveyed through the Vehicle Identification Number, and (e) additional attributes that are important for proper part identification and fitment (block 433). Another example of additional information could be, for instance, notes regarding fitment or application, from the repair facility, the manufacturer, the seller, or from another party having access to the part or to similar parts. In some embodiments, the additional information can be located in the master catalog database 201, and can be retrieved through the query of the master catalog database 201 described in block 421. In other embodiments, the additional can be retrieved through a separate query of the master catalog database 201. In other embodiments, the additional can be retrieved through a query of the availability database 211 or a separate additional information database (not pictured). In some embodiments, the retrieval of the additional data, through a database query or otherwise, is performed by the part matcher 313. In some embodiments, the retrieval of the additional information is performed by the part mapping system 151.

The method also includes the part mapping and procurement system 173 returning the match list to the quoting platform (block 441). In some embodiments, this match list is the list of parts 183 depicted in FIG. 1 and FIG. 2. In some embodiments, this is performed by the part matcher 313. In some embodiments, this is performed by the part mapping system 151.

In some embodiments, the method also includes receiving a purchase order 185 from the quoting platform 171 requesting a purchase of parts identified in a purchase list, the purchase list being a subset of the match list (block 451). In some embodiments, the purchase list includes the subset of the match list that was selected by the repair facility during block 107 of FIG. 1 and that was received by the quoting platform 171 during block 121 of FIG. 1. In some embodiments, the purchase order 185 is received by the fulfillment module 315. In some embodiments, the purchase order 185 is received by the part procurement system 153.

In some embodiments, the method also includes the part mapping and procurement system 173 querying the availability database 211 for shipping information 243 of the parts in the purchase list (block 453). Specifically, the query can be for any one of ship dates, estimated arrival dates, ordering/shipping capabilities, or shipping costs paid or payable. In some embodiments, the part mapping and procurement system 173 also queries for other information, such as price data, part storage locations, or information about vendors/retailers/manufacturers/distributors of parts. In embodiments in which the availability database 211 is connected to the part mapping and procurement system 173 via a network, the query described in block 453 can be a message sent using Hypertext Transfer Protocol (HTTP), Hypertext Transfer Protocol Secure (HTTPS), File Transfer Protocol (FTP), Transport Layer Security (TLS), Secure Sockets Layer (SSL), User Datagram Protocol (UDP), Simple Mail Transfer Protocol (SMTP), Wireless Application Protocol (WAP), Bluetooth or similar communications or security protocols. In embodiments in which the availability database 211 is stored in data store 303, the query described in block 453 can simply be a database lookup, or a similar or analogous function if the availability database 211 is a different data structure. In some embodiments, the query described in block 453 is performed by the fulfillment module 315. In some embodiments, the query described in block 453 is performed by the part procurement system 153. In some embodiments, the query described in block 453 is obtains shipping information 243 for the entire match list rather than only for the purchase list.

In some embodiments, the method also includes the part mapping and procurement system 173 querying an Extended Supplier Network system for shipping information 243 of the parts in the purchase list (block 455). Specifically, the query can be for any one of ship dates, estimated arrival dates, ordering/shipping capabilities, or shipping costs paid or payable. This is also illustrated in block 213 of FIG. 2. In some embodiments, the query of block 455 is performed automatically by the part mapping and procurement system 173 through a network connection that connects the part mapping and procurement system 173 to computer systems in the extended supplier network 223. In other embodiments, the query of block 455 is performed automatically by the part mapping and procurement system 173 through a telephone connection that connects the part mapping and procurement system 173 to computer systems in the extended supplier network 223, such as by text-to-speech system. In some embodiments, the query described in block 455 is obtains shipping information 243 for the entire match list rather than only for the purchase list. In some embodiments, this is performed by the fulfillment module 315. In some embodiments, this is performed by the part procurement system 153.

The method also includes the part mapping and procurement system 173 generating a ship list of the parts that match according to the purchase list (the purchase list generated in block 451) and are available to ship (block 461). In some embodiments, this generation is a receipt of the list from the availability database 211 in response to the query of either block 453 or block 455. In some embodiments, the part mapping and procurement system 173 receives the results of the query from the availability database 211 in real-time or in a piecemeal fashion, and as such must gather the results together in the ship list. In yet other embodiments, the availability database 211 and the master catalog database 201 are part of a single “combined” database, and generation of a match list and ship list can be performed in response to a single query. In some embodiments, the ship list is the order confirmation 187 of FIG. 2. Accordingly, in some embodiments, the ship list can include an invoice 241 detailing the amounts paid or payable. In some embodiments, the ship list can include shipping information 243, which can detail ship dates, estimated arrival dates, and shipping costs paid or payable. In some embodiments, the ship list is generated by the fulfillment module 315. In some embodiments, the ship list is generated by the part procurement system 153.

The term “list” is intended to be exemplary rather than restrictive. The match list can alternately be a data structure such as a database, a table, a matrix, an array, an arraylist, a tree, a hash, a flat file, an image, a queue, a heap, a memory, a stack, a set of registers, or any data structure that can hold data about one or more entities.

In some embodiments, the method also includes the part mapping and procurement system 173 returning the ship list to the quoting platform (block 463). As noted above, in some embodiments, the ship list is the order confirmation 187 of FIG. 2. In some embodiments, returning the ship list is performed by the fulfillment module 315. In some embodiments, returning the ship list is performed by the part procurement system 153.

While the flow diagram in FIG. 4 shows a particular order of operations performed by certain embodiments of the invention, it should be understood that such order is exemplary (e.g., alternative embodiments can perform the operations in a different order, combine certain operations, overlap certain operations, etc.).

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the invention also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures can be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described can be performed in a different order. Moreover, some operations can be performed in parallel rather than sequentially.

Embodiments of the present invention are not described with reference to any particular programming language. It will be appreciated that a variety of programming languages can be used to implement the teachings of embodiments of the invention as described herein.

In the foregoing specification, embodiments of the invention have been described with reference to specific exemplary embodiments thereof. It will be evident that various modifications can be made thereto without departing from the broader spirit and scope of the invention as set forth in the following claims. The specification and drawings are, accordingly, to be regarded in an illustrative sense rather than a restrictive sense.

What is claimed is:

1. A method implemented by a part mapping and procurement system, the method comprising:
receiving a request for a quote (RFQ) for an automotive part from a quoting platform, wherein the quoting platform generated the RFQ based on an estimate generated by an estimating system for automotive repair, wherein the RFQ includes a Vehicle Identification Number, a description of a part to be replaced, and a part number of the part to be replaced;
parsing the description of the part and the part number to generate an interpreted part descriptor and an interpreted part number;
querying a master catalog database for parts that match a fit with the Vehicle Identification Number, the interpreted part descriptor, and the interpreted part number;
generating a match list of the parts returned by the query of the master catalog database; and
returning the match list of the parts to the quoting platform.

2. The method of claim 1, further comprising:
receiving a purchase order from the quoting platform requesting a purchase of parts identified in a purchase list, the purchase list being a subset of the match list; and
generate a ship list of the parts in the purchase list that are available to ship.

3. The method of claim 1, further comprising:
receiving a request to incorporate a second catalog database within the master catalog database; and
appending the second catalog database to the master catalog database.

4. The method of claim 1, wherein parsing the description of the part to generate the interpreted part descriptor and parsing the part number to generate the interpreted part number include one of (a) translating the description of the part that is written in a first language into an interpreted part descriptor that is written in a second language or (b) recognizing and merging or replacing variations in nomenclature in the description of the part, (d) correcting an inaccuracy in the part number or an inaccuracy in the description of the part so that the interpreted part number and the interpreted part descriptor more accurately describe the intended part, (d) recognizing additional attributes of the part and including them in the interpreted part descriptor or in the interpreted part number, the additional attributes including, for example, a required position of the part, a possible required insurance certification of the part, or other attributes that are important for proper part function, identification and fitment, (e) using the part number or the description of the part to determine additional attributes required for proper fitment of a part, and adding these additional attributes to the interpreted part descriptor or to the interpreted part number.

5. The method of claim 1, further comprising:
modifying the match list to include additional information relating to each part in the match list, wherein the additional information is information relating to any one of (a) whether the part has insurance certification, (b) whether the part is new, reconditioned, or remanufactured, (c) whether the part is aftermarket, original equipment quality, discount original equipment, or original equipment, (d) additional vehicle information not conveyed through the Vehicle Identification Number, or (e) additional attributes that are important for proper part identification and fitment.

6. The method of claim 2, further comprising one of:
querying an availability database for shipping information of the parts in the match list; or
querying an Extended Supplier Network system for shipping information of the parts in the match list.

7. A part mapping and procurement system, the system comprising:
a data store;
a processor, the processor coupled to the data store, the processor operable to execute a parser, the parser operable to receive a request for a quote (RFQ) for an automotive part from a quoting platform, wherein the quoting platform generated the RFQ based on an estimate generated by an estimating system for automotive repair, wherein the RFQ includes a Vehicle Identification Number, a description of a part to be replaced, and a part number of the part to be replaced, the parser further operable to parse the description of the part to generate an interpreted part descriptor, the parser further operable to parse the part number of the part to generate an interpreted part number, the processor further operable to execute a part matcher, the part matcher operable to query a master catalog database for parts that match a fit with the Vehicle Identification Number and the interpreted part descriptor, the part matcher further operable to generate a match list the parts returned by the query of the master catalog database.

8. The system of claim 7, wherein the master catalog database is stored in the data store.

9. The system of claim 7, further comprising:
a network module coupled to the processor, the network module operable to access the master catalog database by connecting, through a network, to a second computer system or to a distributed “cloud” storage system.

10. The system of claim 7, wherein the processor is further operable to execute a fulfillment module, the fulfillment module operable to receive a purchase order from the quoting platform requesting a purchase of parts identified in a purchase list, the purchase list being a subset of the match list, the fulfillment module further operable to generate a ship list of the parts in the purchase list that are available to ship.

11. The system of claim 7, wherein the processor is further operable to run a catalog editor, the catalog editor operable to receive a request to incorporate a second catalog database within the master catalog, and to append the second catalog database to the master catalog.

12. The system of claim 7, wherein the parser is further operable to either (a) translate the description of the part that is written in a first language into an interpreted part descriptor that is written in a second language or (b) recognize and merge or replace variations in nomenclature in the description of the part, (c) correcting an inaccuracy in the part number or an inaccuracy in the description of the part so that the interpreted part descriptor and the interpreted part number more accurately describe the intended part, (d) recognizing additional attributes of the part and including them in the interpreted part descriptor or in the interpreted part number, the additional attributes including, for example, a required position of the part, a possible required insurance certification of the part, or other attributes that are important for proper part function, identification and fitment, (e) using the part number or the description of the part to determine additional attributes required for proper fitment of a part, and adding these additional attributes to the interpreted part descriptor or to the interpreted part number.

13. The system of claim 7, wherein the part matcher is further operable to modify the match list to include additional information relating to each part in the match list, wherein the additional information is information relating to any one of (a) whether the part has insurance certification, (b) whether the part is new, reconditioned, or remanufactured, (c) whether the part is aftermarket, original equipment quality, discounted original equipment, or original equipment, (d) additional vehicle information not conveyed through the Vehicle Identification Number, or (e) additional attributes that are important for proper part identification and fitment.

14. The system of claim 10, wherein the fulfillment module is further operable to perform one of (a) querying an availability database for shipping information of the parts in the match list, or (b) querying an Extended Supplier Network system for shipping information of the parts in the match list.

15. A non-transitory machine-readable storage medium that stores instructions that, if executed by a processor of part mapping and procurement system, will cause said processor to perform operations comprising:
receiving a request for a quote (RFQ) for an automotive part from a quoting platform, wherein the quoting platform generated the RFQ based on an estimate generated by an estimating system for automotive repair, wherein the RFQ includes a Vehicle Identification Number, a description of a part to be replaced, and a part number of the part to be replaced;
parsing the description of the part and the part number to generate an interpreted part descriptor and an interpreted part number;
querying a master catalog database for parts that match a fit with the Vehicle Identification Number, the interpreted part descriptor, and the interpreted part number;
generating a match list of the parts returned by the query of the master catalog database; and
returning the match list of the parts to the quoting platform.

16. The non-transitory machine-readable storage medium of claim 15, further comprising:
receiving a purchase order from the quoting platform requesting a purchase of parts identified in a purchase list, the purchase list being a subset of the match list; and
generate a ship list of the parts in the purchase list that are available to ship.

17. The non-transitory machine-readable storage medium of claim 15, the operations further comprising:
receiving a request to incorporate a second catalog database within the master catalog; and
appending the second catalog database to the master catalog.

18. The non-transitory machine-readable storage medium of claim 15, wherein parsing the description of the part to generate the interpreted part descriptor and parsing the part number to generate the interpreted part number include one of (a) translating the description of the part that is written in a first language into an interpreted part descriptor that is written in a second language or (b) recognizing and merging or replacing variations in nomenclature in the description of the part, (d) correcting an inaccuracy in the part number or an inaccuracy in the description of the part so that the interpreted part number and the interpreted part descriptor more accurately describe the intended part, (d) recognizing additional attributes of the part and including them in the interpreted part descriptor or in the interpreted part number, the additional attributes including, for example, a required position of the part, a possible required insurance certification of the part, or other attributes that are important for proper part function, identification and fitment, (e) using the part number or the description of the part to determine additional attributes required for proper fitment of a part, and adding these additional attributes to the interpreted part descriptor or to the interpreted part number.

19. The non-transitory machine-readable storage medium of claim 15, the operations further comprising:
modifying the match list to include additional information relating to each part in the match list, wherein the additional information is information relating to any one of (a) whether the part has insurance certification, (b) whether the part is new, reconditioned, or remanufactured, (c) whether the part is aftermarket, original equipment quality, discount original equipment, or original equipment, (d) additional vehicle information not conveyed through the Vehicle Identification Number, or (e) additional attributes that are important for proper part identification and fitment.

20. The non-transitory machine-readable storage medium of claim 16, further comprising one of:
querying an availability database for shipping information of the parts in the match list; or
querying an Extended Supplier Network system for shipping information of the parts in the match list.
